(19) United States
(12) Patent Application Publication
(10) Pub. No.: US 2023/0338876 A1
(43) Pub. Date: Oct. 26, 2023

(54) HYDROCARBON ABSORBING FILTER

(71) Applicant: James Newsome, Memphis, MI (US)

(72) Inventor: James Newsome, Memphis, MI (US)

(21) Appl. No.: 18/136,029

(22) Filed: Apr. 18, 2023

Related U.S. Application Data
(60) Provisional application No. 63/332,758, filed on Apr. 20, 2022.

(51) Int. Cl. B01D 29/00; B01D 35/00; B01D 35/34

(52) U.S. Cl. CPC B01D 29/0097; B01D 35/005; B01D 35/34; B01D 2201/02; B01D 2201/18; B01D 2201/302

(57) ABSTRACT

A hydrocarbon absorbing cone filter for an air intake system may include a generally truncated cone shaped media filter and an internal hydrocarbon absorbing element therein. The hydrocarbon absorbing element may absorb hydrocarbons at the clean air side of an air stream flowing through the media filter and into a combustion engine system.

### CROSS-REFERENCE TO RELATED APPLICATIONS

This application claims the benefit of U.S. Provisional Application No. 63/332,758 filed Apr. 20, 2022.

### TECHNICAL FIELD

This disclosure generally relates to the field of hydrocarbon absorption in air filters.

### BACKGROUND

Filters for air intake systems for internal combustion engines may require hydrocarbon absorption to meet industry standards or regulations.

Existing hydrocarbon absorbing filters utilize hydrocarbon absorbing coatings, pass-through screens, pass-through filters, or external hydrocarbon vapor-absorbent members.

Existing filters require total replacement of traditional media air filters and are not an efficient or cost-effective solution for retrofitting air induction systems to meet industry standards or regulations.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A hydrocarbon absorbing cone filter for an internal combustion engine may include a media filter and a hydrocarbon absorbing element integrated therein. The hydrocarbon absorbing cone filter may allow for compliance with industry standards or regulations without retooling or modifying a non-compliant air induction system in a vehicle, tool, or other system implementing a combustion engine.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of a hydrocarbon absorbing cone filter as described herein;

FIG. 2 illustrates a cross-sectional view of a hydrocarbon absorbing cone filter as described herein;

FIG. 3 illustrates a cross-sectional view of a hydrocarbon absorbing cone filter as described herein; and

FIG. 4 illustrates a cross-sectional view of a hydrocarbon absorbing cone filter as described herein; and

FIG. 5 illustrates an exploded view of a hydrocarbon absorbing cone filter as described herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used to distinguish one entity or element from another entity or element without necessarily requiring or implying any physical or logical relationship, or order between such entities or elements.

In general, the embodiments described herein relate to a hydrocarbon absorbing cone filter for an internal combustion engine including a generally cone shaped media filter and an internal hydrocarbon absorbing element. In use, air may flow from an external environment through the generally cone shaped media filter into a clean air side and through or over the internal hydrocarbon absorbing element and subsequently into an air intake system. When air containing hydrocarbons is passed over or through a hydrocarbon absorber material, hydrocarbon molecules become trapped within the pores of the hydrocarbon absorber material. The clean air is then released from the absorber, while the hydrocarbons remain trapped within the hydrocarbon absorber material.

The hydrocarbon absorbing element may absorb hydrocarbon emissions at the clean air side of an air stream flowing through the cone filter and into a combustion engine system. The hydrocarbon absorbing element may be a standalone disc, pad, or pack of hydrocarbon absorbing particles working in tandem with the media filter.

The hydrocarbon absorbing cone filter may include a media filter positioned between an outlet collar and an inlet cap. The media filter may include paper, cotton gauze, foam, metal, or other suitable media filter constructed and arranged to filter air.

A hydrocarbon absorbing element, such as a disc, pad, or pack of hydrocarbon absorbing particles or granules, may be attached to or integrated into the inlet cap such that hydrocarbons may be absorbed while minimizing restriction of airflow through an inlet side of the media filter to an outlet side of the media filter. The hydrocarbon absorbing element may include granular activated carbon, powdered activated carbon, zeolite, or silica gel having high porosity or large surface area.

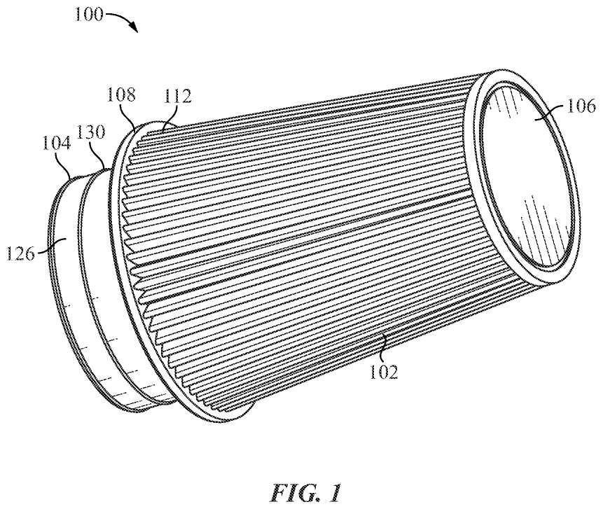

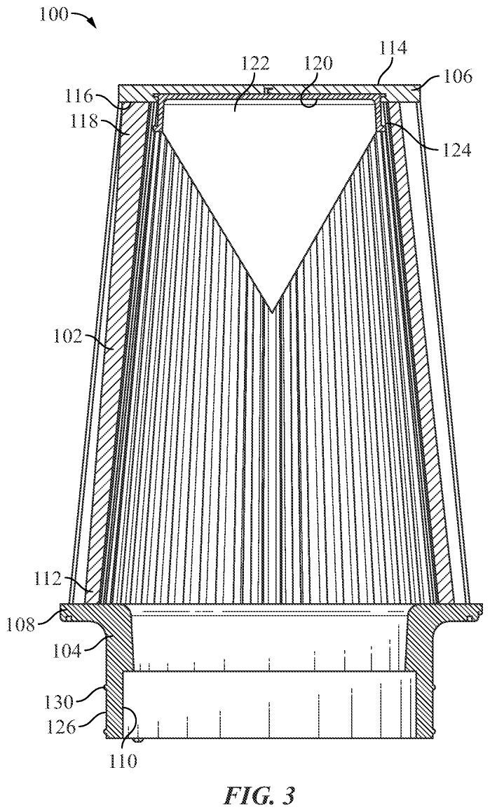

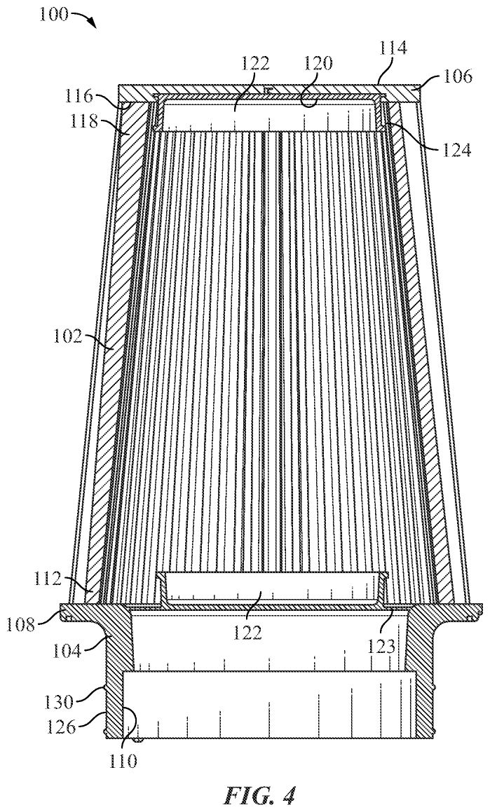

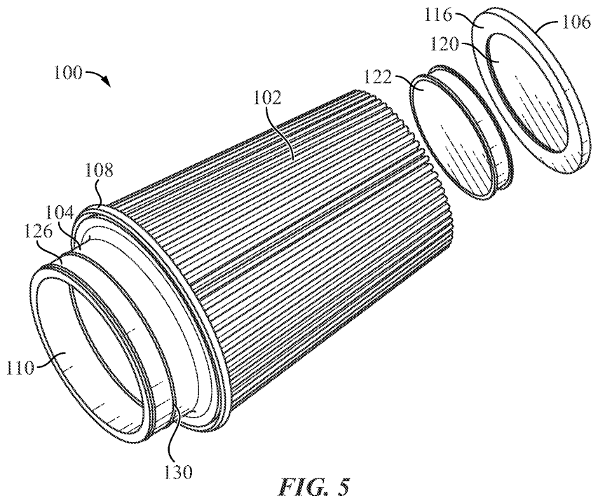

While FIGS. 1-5 generally depict a truncated cone shaped filter including a hydrocarbon absorbing elements, it should be understood that the media filter, hydrocarbon absorbing element, inlet cap, and outlet collar may take various forms, shapes, and sizes to account for varying use cases or scenarios and still fall within the scope of this disclosure.

FIGS. 1 through 5 illustrate a hydrocarbon absorbing cone filter 100. The cone filter 100 may include a generally cone shaped, or truncated cone shaped, media filter 102 positioned between an outlet collar 104 and an inlet cap 106. The outlet collar 104 may include a base flange 108 constructed and arranged to receive a first end 112 of the media filter 102 thereon. The outlet collar 104 may including an attachment flange 126 defining, in cooperation with the base flange 108, an outlet channel 110 therein for the passage of fluid such as air. The outlet collar 104 may be constructed and arranged for attachment to air induction systems having a combustion engine system via at least one outer rib 130 on the attachment flange 126.

The inlet cap 106 may be generally disk shaped and may include an outer surface 114 opposite an inner surface 116, the inner surface 116 being constructed and arranged to attach to a second end 118 of the media filter 112. The inlet cap 106 may define a recess 120 in the inner surface 116, such as via an inlet collar, to at least partially house or connect a hydrocarbon absorbing element 122 therein.

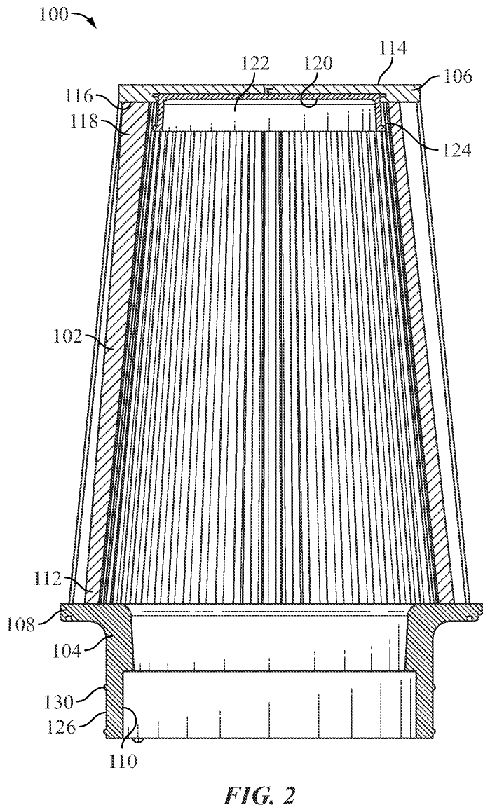

As best seen in FIGS. 2-4 the hydrocarbon absorbing element 122 and media filter 112 may not be in physical contact with one another and may define a circumferential gap 124 therebetween. Each of the hydrocarbon absorbing element 122 and media filter 112 may be removable or replaceable within the hydrocarbon absorbing cone filter 100. The hydrocarbon absorbing element 122 may include granulated carbon, a carbon impregnated resin, or the like. According to some embodiments, the hydrocarbon absorbing element may take on a variety of shapes and sizes dependent on desired rate of hydrocarbon capture. The hydrocarbon absorbing element 122 may be formed as a portion of the cap 106 or the hydrocarbon absorbing element 122 may make up the inlet cap 106 in its entirety. According to come embodiments, the hydrocarbon absorbing element 122 may be integrated with the outlet collar 104 via supports 123.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a hydrocarbon absorbing filter may include a media filter including a first end opposite a second end, an environment facing surface opposite a clean air facing surface, wherein the media filter defines a clean air passage; and an internal hydrocarbon absorbing element disposed within the clean air passage.

Variation 2 may include a hydrocarbon absorbing filter as in claim 1, wherein absorb hydrocarbon emissions at a clean air side of an air stream flowing through the media filter and into a combustion engine system.

Variation 3 may include a hydrocarbon absorbing filter as in claim 1 or 2, wherein air may flow from an external environment through the media filter into a clean air side and through or over the internal hydrocarbon absorbing element and subsequently into an air intake system.

Variation 4 may include a hydrocarbon absorbing filter as in any of claims 1 through 3, further including an inlet cap attached to the first end, the inlet cap having a cap exterior surface and a cap interior surface.

Variation 5 may include a hydrocarbon absorbing filter as in any of claims 1 through 4, further including an outlet collar attached to the second end.

Variation 6 may include a hydrocarbon absorbing filter as in any of claims 1 through 5, wherein the outlet collar defines a flow-through channel constructed and arranged to channel fluid flow from the clean air passage through the flow-through channel.

Variation 7 may include a hydrocarbon absorbing filter as in any of claims 1 through 6, wherein the internal hydrocarbon absorbing element is disposed on the inlet cap.

Variation 8 may include a hydrocarbon absorbing filter as in any of claims 1 through 7, wherein the internal hydrocarbon absorbing element is disposed on the cap interior surface.

Variation 9 may include a hydrocarbon absorbing filter as in any of claims 1 through 8, further including an inlet cap attached to the first end, the inlet cap having a cap exterior surface, an inner surface, and defining a recess in the inner surface to at least partially house or connect the hydrocarbon absorbing element therein.

Variation 10 may include a hydrocarbon absorbing filter as in any of claims 1 through 9, wherein the internal hydrocarbon absorbing element is not in contact with the media filter.

Variation 11 may include a hydrocarbon absorbing filter as in any of claims 1 through 10, wherein the hydrocarbon absorbing element is formed as a portion of an inlet cap.

Variation 12 may include a hydrocarbon absorbing filter as in any of claims 1 through 11, wherein the hydrocarbon absorbing element forms an inlet cap in its entirety.

Variation 13 may include a hydrocarbon absorbing filter as in any of claims 1 through 12, wherein the hydrocarbon absorbing element defines a circumferential gap between the hydrocarbon absorbing element and the media filter.

Variation 14 may include a hydrocarbon absorbing filter as in any of claims 1 through 13, wherein the media filter is generally truncated cone in shape.

According to variation 15, a hydrocarbon absorbing filter may include generally truncated cone media filter including a first end opposite a second end, an environment facing surface opposite a clean air facing surface, wherein the media filter defines a clean air passage; an inlet cap attached to the first end, the inlet cap having a cap exterior surface, an inner surface, and defining a recess in the inner surface; an outlet collar attached to the second end; and an internal hydrocarbon absorbing element disposed within the clean air passage.

Variation 16 may include a hydrocarbon absorbing filter as in claim 15, wherein the internal hydrocarbon absorbing element is integrated with the outlet collar via at least one support.

Variation 17 may include a hydrocarbon absorbing filter as in any of claim 15 or 16, wherein the internal hydrocarbon absorbing element is disposed in the recess in the inner surface.

Variation 18 may include a hydrocarbon absorbing filter as in any of claims 15 through 17, wherein the internal hydrocarbon absorbing element is not in contact with the media filter.

Variation 19 may include a hydrocarbon absorbing filter as in any of claims 15 through 18, wherein the internal hydrocarbon absorbing element includes at least one of granular activated carbon, powdered activated carbon, zeolite, or silica gel.

According to variation 20, a hydrocarbon absorbing filter may include a generally truncated cone media filter including a first end opposite a second end, an environment facing surface opposite a clean air facing surface, wherein the media filter defines a clean air passage; an inlet cap attached to the first end, the inlet cap having a cap exterior surface, an inner surface, and defining a recess in the inner surface; an outlet collar attached to the second end; and an internal hydrocarbon absorbing element including at least one of a granular activated carbon, powdered activated carbon, zeolite, or silica gel, the internal hydrocarbon absorbing element being disposed in the recess in the inner surface.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A hydrocarbon absorbing filter, comprising:
a media filter comprising a first end opposite a second end, an environment facing surface opposite a clean air facing surface, wherein the media filter defines a clean air passage; and
an internal hydrocarbon absorbing element disposed within the clean air passage.

2. A hydrocarbon absorbing filter as in claim 1, wherein absorb hydrocarbon emissions at a clean air side of an air stream flowing through the media filter and into a combustion engine system.

3. A hydrocarbon absorbing filter as in claim 1, wherein air may flow from an external environment through the media filter into a clean air side and through or over the internal hydrocarbon absorbing element and subsequently into an air intake system.

4. A hydrocarbon absorbing filter as in claim 1, further comprising an inlet cap attached to the first end, the inlet cap having a cap exterior surface and a cap interior surface.

5. A hydrocarbon absorbing filter as in claim 4, further comprising an outlet collar attached to the second end.

6. A hydrocarbon absorbing filter as in claim 5, wherein the outlet collar defines a flow-through channel constructed and arranged to channel fluid flow from the clean air passage through the flow-through channel.

7. A hydrocarbon absorbing filter as in claim 4, wherein the internal hydrocarbon absorbing element is disposed on the inlet cap.

8. A hydrocarbon absorbing filter as in claim 4, wherein the internal hydrocarbon absorbing element is disposed on the cap interior surface.

9. A hydrocarbon absorbing filter as in claim 1, further comprising an inlet cap attached to the first end, the inlet cap having a cap exterior surface, an inner surface, and defining a recess in the inner surface to at least partially house or connect the hydrocarbon absorbing element therein.

10. A hydrocarbon absorbing filter as in claim 1, wherein the internal hydrocarbon absorbing element is not in contact with the media filter.

11. A hydrocarbon absorbing filter as in claim 1, wherein the hydrocarbon absorbing element is formed as a portion of an inlet cap.

12. A hydrocarbon absorbing filter as in claim 1, wherein the hydrocarbon absorbing element forms an inlet cap in its entirety.

13. A hydrocarbon absorbing filter as in claim 1, wherein the hydrocarbon absorbing element defines a circumferential gap between the hydrocarbon absorbing element and the media filter.

14. A hydrocarbon absorbing filter as in claim 1, wherein the media filter is generally truncated cone in shape.

15. A hydrocarbon absorbing filter, comprising:
a generally truncated cone media filter comprising a first end opposite a second end, an environment facing surface opposite a clean air facing surface, wherein the media filter defines a clean air passage;
an inlet cap attached to the first end, the inlet cap having a cap exterior surface, an inner surface, and defining a recess in the inner surface;
an outlet collar attached to the second end; and
an internal hydrocarbon absorbing element disposed within the clean air passage.

16. A hydrocarbon absorbing filter as in claim 15, wherein the internal hydrocarbon absorbing element is integrated with the outlet collar via at least one support.

17. A hydrocarbon absorbing filter as in claim 15, wherein the internal hydrocarbon absorbing element is disposed in the recess in the inner surface.

18. A hydrocarbon absorbing filter as in claim 15, wherein the internal hydrocarbon absorbing element is not in contact with the media filter.

19. A hydrocarbon absorbing filter as in claim 15, wherein the internal hydrocarbon absorbing element comprises at least one of granular activated carbon, powdered activated carbon, zeolite, or silica gel.

20. A hydrocarbon absorbing filter, comprising:
a generally truncated cone media filter comprising a first end opposite a second end, an environment facing surface opposite a clean air facing surface, wherein the media filter defines a clean air passage;
an inlet cap attached to the first end, the inlet cap having a cap exterior surface, an inner surface, and defining a recess in the inner surface;
an outlet collar attached to the second end; and
an internal hydrocarbon absorbing element comprising at least one of a granular activated carbon, powdered activated carbon, zeolite, or silica gel, the internal hydrocarbon absorbing element being disposed in the recess in the inner surface.
